(19) United States
(12) Patent Application Publication
(10) Pub. No.: US 2007/0130086 A1
(43) Pub. Date: Jun. 7, 2007

(54) MATERIAL HANDLING CALCULATOR

(75) Inventors: Teresa Chao, Richardson, TX (US); Kirk Nativi, Frisco, TX (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: FREEMAN CAPITAL COMPANY, Las Vegas, NV (US)

(21) Appl. No.: 11/557,398

(22) Filed: Nov. 7, 2006

Related U.S. Application Data
(60) Provisional application No. 60/734,520, filed on Nov. 7, 2005.

(51) Int. Cl. G06Q 99/00

(52) U.S. Cl. 705/75

(57) ABSTRACT

The present invention relates to systems and methods for calculating a cost for material handling. In particular, embodiments of the present invention relate to systems and methods for booth related materials for providing a user with the ability to accurately calculate and store material handling estimates for one or more exhibition shows in which they are participating. In one embodiment the material handling calculator may include screens for selecting the booth number, the location, the packaging parameters, and the weight to be shipped. The material handling calculator may utilize this information and provide a summary and then an estimate of the material handling cost for that show. In other embodiments the material handling calculator may also provide the material handling estimate for a number of shows.

### CROSS REFERENCE TO RELATED APPLICATIONS

The present application claims priority to U.S. patent application Ser. No. 60/734,520, filed on Nov. 7, 2005, entitled “Material Handling Calculator,” which application is incorporated herein by reference in its entirety.

### FIELD OF THE INVENTION

The present invention relates to systems and methods for calculating a cost for material handling. In particular, embodiments of the present invention relate to systems and methods for providing an exhibitor with the ability to accurately calculate and store material handling estimates for one or more exhibition shows in which the exhibitor is participating.

### BACKGROUND OF THE INVENTION

Exhibition system ordering services may consist of many options which may be confusing to a first time or even experienced exhibitor. Assisting and guiding the exhibitor through the potentially confusing process of ordering services for an exhibition may be particularly labor intensive. For example, many systems only list the options and services available without any explanation about what the options mean or what the services entail. The charts of rate information may not have included precise definitions, guides, or examples to help the user select the proper rates. Furthermore, exhibitors may find it difficult to determine the appropriate cost estimate for handling their materials after they arrive at the exhibition. As a result, significant confusion and error may result in determining the costs associated with presenting at the exhibition. Or, even worse, the exhibitor does not actually arrange for such services to be provided.

Prior art systems for determining material handling charges may only provide handling descriptions and rates for the selected show in a table or chart format. With these systems, exhibitors may find it difficult to determine the appropriate rate to use when attempting to calculate their estimated material handling costs. Furthermore, the exhibitors must also manually calculate their estimates. As such, the exhibitor services and help desk personnel may spend a considerable amount of time helping exhibitors calculate these costs.

A need therefore exists for an automated system and method that helps exhibitors to determine the cost associated with material handling as it relates to an exhibition booth and presenting at an exhibition or show.

### BRIEF SUMMARY OF THE INVENTION

One embodiment of the present invention may include an automated method for assisting a user in estimating material handling costs for delivering materials to an exhibition booth including electronically soliciting from a user a booth number where the materials for the exhibition booth will be displayed, electronically soliciting from the user a location to which the materials are going to be shipped, electronically soliciting from the user a description of how the materials are packed for shipment, electronically soliciting from the user a weight of the materials to be shipped, storing electronically the information provided by the user, electronically calculating a cost associated with handling the materials based upon the solicited information, and displaying the cost to the user.

Another embodiment of the present invention may be an automated method for assisting a user in estimating the cost of material handling for presenting an exhibition booth that includes electronically providing a set of queries to a user relating to the materials to be displayed at an exhibition booth for an exhibition, receiving answers in response to the queries, the answers indicating a characteristic of the materials and a packaging parameter, electronically storing the answers, electronically calculating a cost based upon the answers, and summarizing the cost associated with the first set of queries and the additional set of queries.

Yet another embodiment of the present invention may include a system for estimating material handling costs for presenting an exhibition booth that includes a database o queries relating to presenting the exhibition booth, a database of rates electronically linked to the database of queries, a user interface for presenting a user with the queries in a desired order, a means for electronically storing answers to the queries provided by the user, and a means for electronically calculating an estimate based upon the answers to the queries provided by the user and the database of rate.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a block diagram displaying a flow chart of one embodiment exhibitor assistant of the present invention method.

FIGS. 2-17 illustrate exemplary embodiment screen shots of one embodiment of the present invention exhibitor assistant system.

### DETAILED DESCRIPTION

Systems and methods for a material handling calculator are described. According to one embodiment of the present invention, the material handling calculator provides enhanced capabilities to allow exhibitors to accurately calculate and store material handling estimates for exhibitions or other shows. In one embodiment, the calculator helps the exhibitor determine the appropriate rate to use for the handling of the materials and automatically calculates the estimated cost. To do this, the calculator may employ a question/answer paradigm to guide the exhibitor through the calculation process using familiar language. The exhibitors can store these estimates for future reference on a per show and/or per booth basis. The material handling estimate totals may be provided on an account summary screen in order to provide the exhibitor with a more complete picture of the projected costs. In addition, the calculator may also serve as a tool to help exhibitors understand material handling charges. The estimates may also be accessible to one or more exhibitor services in order to help support exhibitors. By providing the user this tool, the user will be able to manage budgets more accurately and have fewer questions regarding the invoiced material handling charges.

The present invention will be referred to herein as a “material handling calculator,” which refers generally to the entire system and method of presenting questions and information to the exhibitor and gathering information and responses from the exhibitor. The questions and information are presented to the exhibitor by a “provider” who is a provider of services for the exhibition or show. The provider may be any company, individual, organization, show committee, or other group that may need a system and method for estimating material handling cost. The information, questions, and graphics may be presented on a “screen” or “page” that includes text, pictures, hyperlinks, and other features and characteristics as known in the art. The terms “screen” and “page” may be used interchangeably throughout the present description.

The term “material handling calculator” is not intended to, and does not in any way, limit the scope of the present invention, but is only convenient shorthand to reference all of the options, information, and selectable tools that are a part of the present invention system and method. Materials that are to be handled may include booths, posters, displays, example products, free gifts, and other paraphernalia that may be displayed and utilized at an exhibition booth. The present invention is also described in terms of a “booth” and an “exhibition.” Neither of these terms should be construed as limiting as “booths” and “exhibitions” can encompass a wide range of displays and presentations at conventions, meetings, shows, or other gatherings. The terms “exhibitor,” “customer,” and “user” all are used to refer to an individual, group of individuals, or a company that may use or access the material handling calculator. Finally, the information, questions, and graphics may be presented on a “screen” or “page” that includes text, pictures, hyperlinks, and other characteristics as known in the art. The terms “screen” and “page” may be used interchangeably throughout the present description.

In the following description, numerous specific details are set forth in order to provide a thorough understanding of embodiments of the present invention. It will be apparent to one skilled in the art, however, that embodiments of the present invention may be practiced without some of these specific details. In other instances, well-known structures and devices may be added without changing the spirit and scope of the present invention. The present illustration is not intended to be exhaustive, but rather to highlight some of the benefits and advantages associated with various embodiments and features of a material handling calculator.

Embodiments of the present invention may include a variety of features and steps as described below. The steps may be performed by hardware components or may be embodied in machine-executable instructions. The instructions may be used to cause a general-purpose or special-purpose processor programmed with the instructions to perform the steps. Alternatively, the steps may be performed by a combination of hardware, software and/or firmware.

While, for convenience, embodiments of the present invention are described with reference to computing material handling costs in relation to exhibitions, other embodiments of the present invention may be equally applicable to various other operational models. For example, the material handling calculator described herein may be integrated with or form part of a larger system that relates to exhibition services. Indeed, it is contemplated that embodiments of the present invention may be locally hosted and implemented on one or more web sites. According to one embodiment, users of the system may be required to be logged in to the system in order to store estimates and perform material handling calculations. Alternatively, the material handling calculator may be distributed by exhibition organizers as an independent software package or utility which may be directly installed on an end users' computer.

In one embodiment, the system may provide functionality to assist exhibitor services personnel at the show site. For example, the system may allow exhibitor services personnel to view the material handling estimates at the show. In one embodiment, the system may calculate an estimate based, at least in part, on cumulative weights of shipments. In another embodiment, the estimate for the material handling includes unloading and loading of exhibits. Some shows may have a separate rate for unloading materials and transporting the materials to the booth and a rate for loading materials onto outbound carriers. In another embodiment, a set weight minimum may be required before the estimate is provided.

In one embodiment, an account summary page may include all of the estimates for material handling for an exhibition. Moreover, the exhibitor may estimate material handling charges online and store those estimates on a per show basis. Help pages may be provided to explain the functionality of the material handling calculator. In another embodiment, the material handling calculator may provide a series of questions to help the user to determine the appropriate rate. The questions and rates applied may be based on the material handling rates set for each particular show. According to various embodiments, the material handling calculator may display the material handling rates on line.

In another embodiment, a link to warehouse and show site shipping labels may be provided. In one embodiment, the warehouse shipping address per branch may be displayed as well as the show specific facility ship to address. In addition, the ability to enter a show's warehouse shipping address per branch as well as the show specific facility ship to address may be provided.

In another embodiment, various descriptions and pictures may be provided where appropriate to help explain the various material handling aspects. As may be appreciated, questions, rates provided, and other information may be different for international exhibitors. Some embodiments may provide a disclaimer to explain that the material handling calculation is only an estimate based on the user's inputs. The actual amount may change at show site based on actual weight and time of service.

As may be appreciated, the questions, answers, and actions provided by the exhibitor assistant will be maintained by database administrators. The database administrators may provide questions that relate to products and services depending on the type and location of the show. In addition, the database administrators may need to adjust pricing structure depending on the show. In other embodiments the database may be maintained in any manner desired. In some embodiments the system may access a service. In further embodiments the material handling calculator may be linked to the provider's internal database and information.

One embodiment provides special instructions for packaged shows and may disable the calculator for these types of shows. In one embodiment, an administrator may be allowed to enter a detailed description about material handling for packaged shows. The administrator may also be allowed to manage the material handling attributes used to determine rates for the material handling calculator.

### EXAMPLE

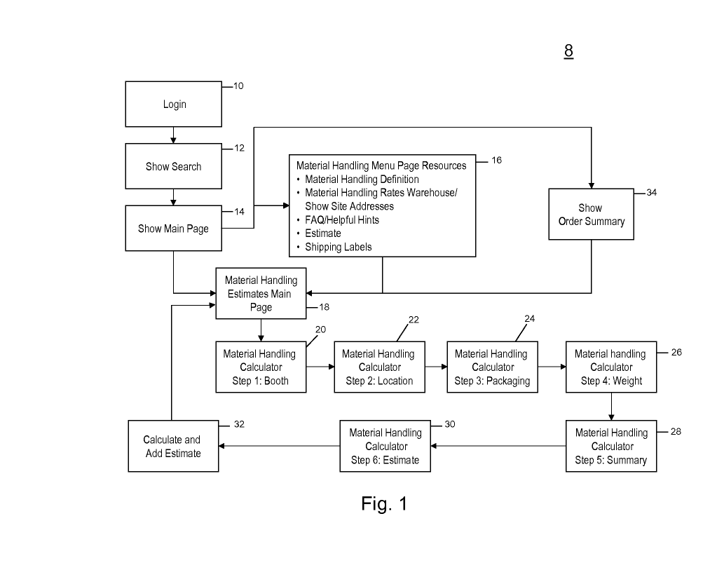

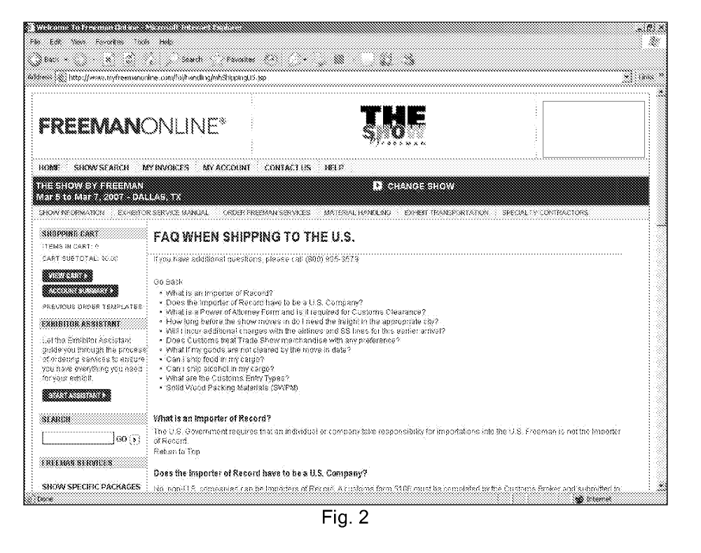

With reference to FIGS. 1-17, one example of a material handling calculator 8 of the present invention will now be described. FIG. 1 illustrates a block diagram of one example of how the pages and screens of the present invention may be linked together to form a material handling calculator 8. FIGS. 2-17 may illustrate example screens and pages that are presented to the user for gathering the information required to create the estimate. In the below description, the example screen shots will be referred to by a specific figure number and various blocks in FIG. 1 will be referenced parenthetically.

The pages and features of this example will be herein described from the perspective of a “user” or a “customer” who enters information and selects options. The user may be a customer logging into the system through remote access or may be a customer using software installed on the customer's computer. Downloaded software may require uploading the inputted information to the provider after the information is entered into the material handling calculator 8 by the user. In other embodiments, the information may be printed and faxed to the provider. The present example of the material handling calculator 8 is described in terms of a user accessing the system through the internet.

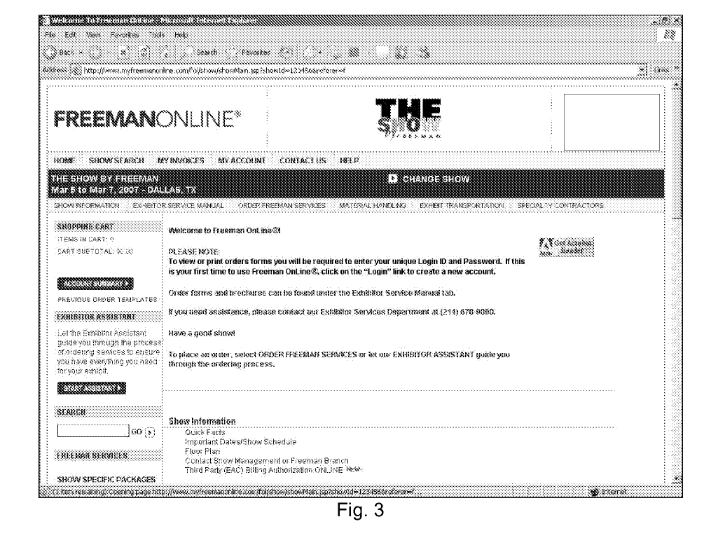

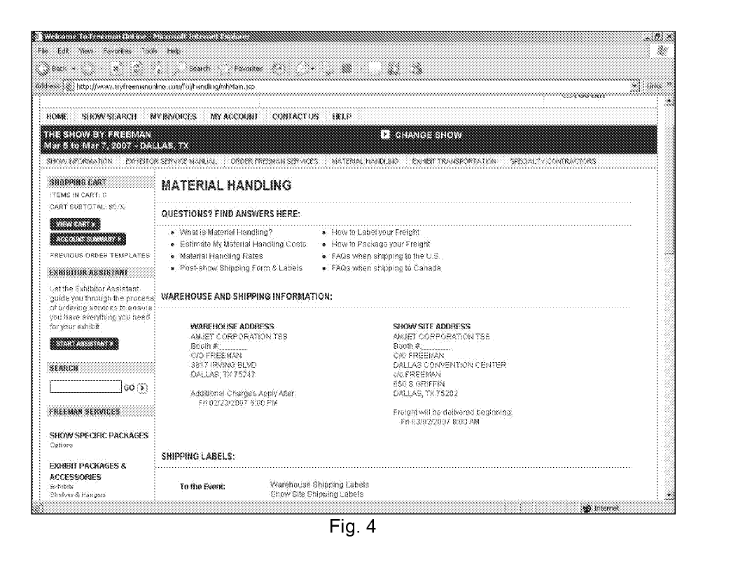

As illustrated in FIGS. 2 and 3, the user may access the material handling calculator 8 from a page presented by the provider. The pages may be part of a website or other program provided by the provider. One such system is described in U.S. Provisional Application No. 60/734,521, and the co-pending U.S. Utility application entitled “Exhibitor Assistant,” application Ser. No. ______,filed concurrently with the present application, which are both incorporated herein by reference in their entirety. Regardless of the entry point utilized by the user, when the “Material Handling” icon is selected by the user, the material handling calculator 8 may present an initial welcome or menu page as illustrated in FIG. 4. Other screens may include a login page (FIG. 1, block 10), a show search page (FIG., block 12), or a provider main page (FIG. 1, block 14).

According to one embodiment, the menu page as illustrated in FIG. 4 (FIG. 1, block 16) may include hyperlinks for the material handling calculator 8 itself and also links to other information relating to material handling, such as pages related to explaining material handling and material handling tips/FAQ. Other information that may be accessible from the initial page may include how to label and pack freight, how to ship products, links to shipping labels, and frequently asked questions relating to shipping in the U.S. and Canada. Each question may direct the user to another page with the requested information. According to one embodiment, the material handling calculator 8 may not be available unless the user is logged in and associated with the selected show.

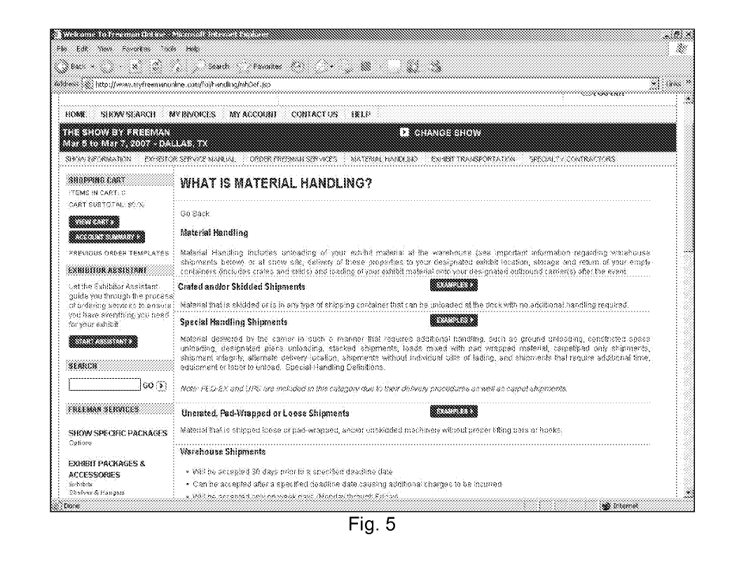

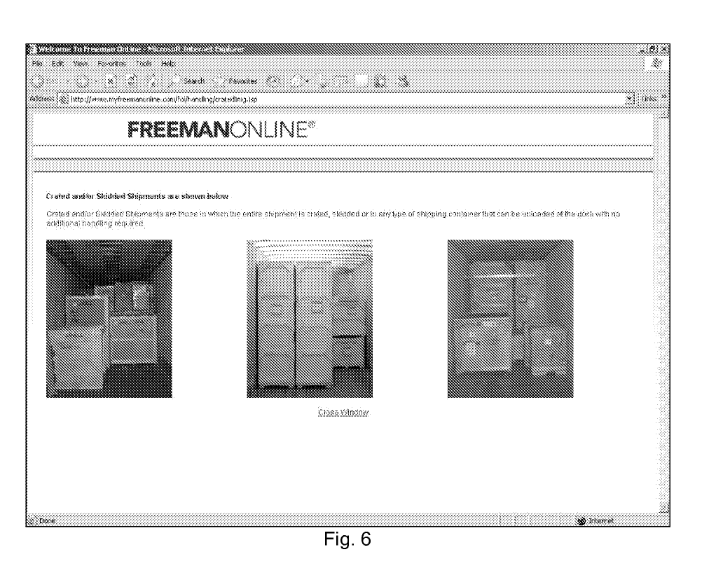

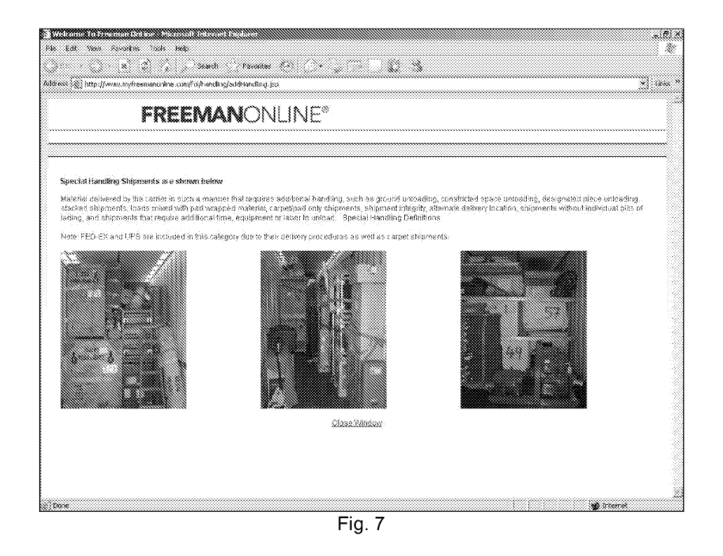

FIG. 5 illustrates an example page that may be presented when the user selects the hyperlink “What is Material Handling?”. As illustrated, the page may explain the nature of material handling and also explain different categories of how shipments are packaged. As may be appreciated, selection of the “Example” hyperlink associated with each packaging option may display examples of that particular packaging method. FIGS. 6 and 7 may illustrate examples of different methods of packaging materials for shipment to the exhibition site. Providing examples of the material packaging options allows the user to better select the appropriate package method and the material handling calculator 8 to more accurately estimate the material handling cost for the user's materials.

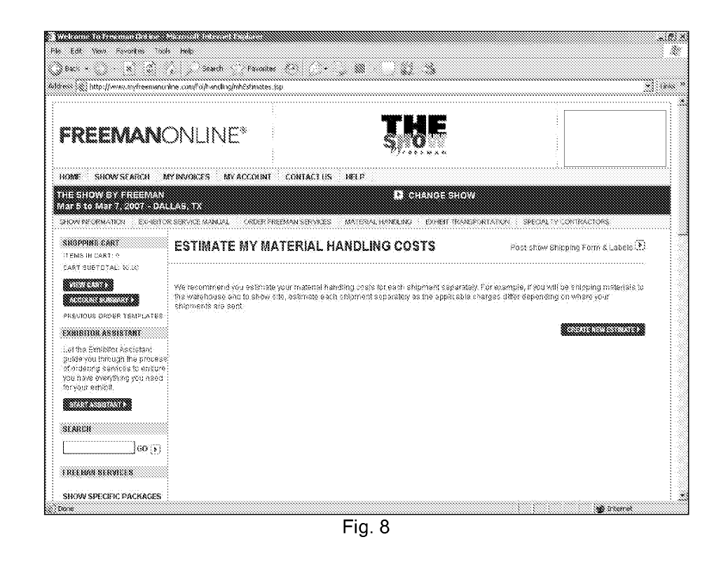

When the user selects the hyperlink for “Estimate My Material Handling Costs,” the system may open a page as illustrated in FIG. 8 (FIG. 1, block 18). According to one embodiment, if this is a packaged show, the selected show link description may change to “Package Show Information,” which allows the user to navigate to a page that displays the package show description, carpet color, and other package show information. The material handling menu page may also display one or more of the warehouse and show site addresses, dates, links to shipping labels, and the like. In the present embodiment, the user may select “Create New Estimate” to begin.

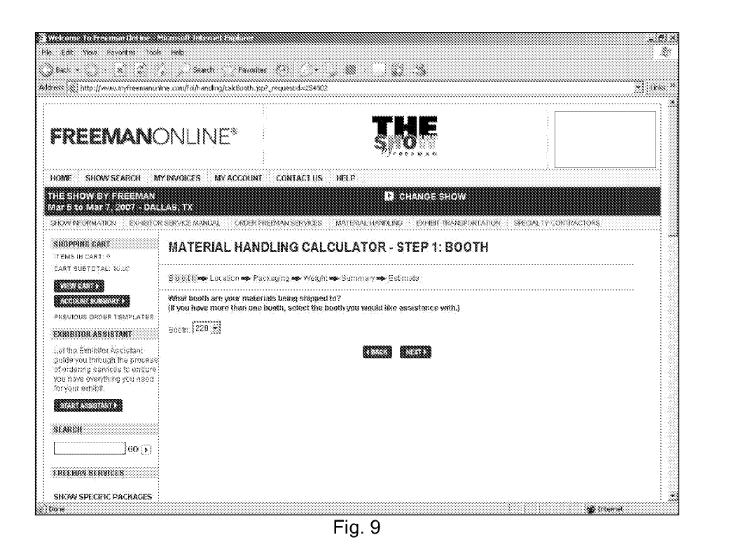

After selecting “Create New Estimate,” the user may be presented with a booth selection screen as illustrated in FIG. 9 (FIG. 1, block 20). The booth may be chosen from an interactive user interface such as a drop down list of possible booths or other interfaces known to those skilled in the art. In one embodiment, the list may be populated with the booths associated with the user's record. Selection of the proper booth allows the material handling calculator 8 to properly estimate the cost of handling the user's materials at the exhibition. If the user does not select a booth, the user may receive an error message stating that a booth is required.

As illustrated, the page may also include a “Back” button linked to the material handling calculator 8 main page or to the previous question. As may be appreciated, all of the pages described herein my have a similar feature for navigating through the material handling calculator 8.

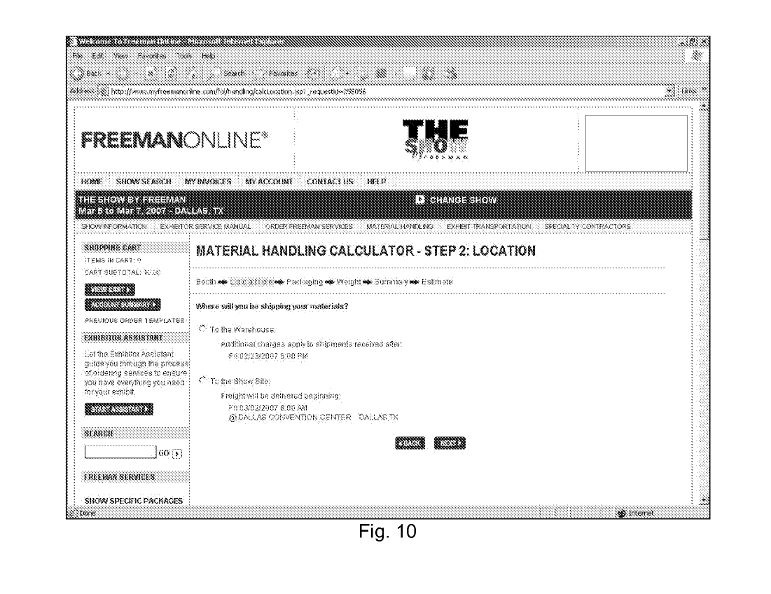

In the present embodiment, the user may select a booth from the list and then press the “Next” button to be presented with another example screen as shown in FIG. 10 (FIG. 1, block 22). The screen illustrated in FIG. 10 may allow the user to select a shipping destination. The ship to location options can be a warehouse, a show site, or other site related to the exhibition. As illustrated in the present embodiment, the page shown in FIG. 10 may display the show site and warehouse options with the deadline dates as well as a link to a shipping labels file, if available. As may be appreciated, depending on the shipping date, the user's materials may not be shipped directly to the exhibition or may require additional fees for shipment. Each shipping option may display the appropriate dates. In some embodiments, links to shipping label forms are also available for each site. A view of the show floor plan, or other views of the show location, may be available for some shows.

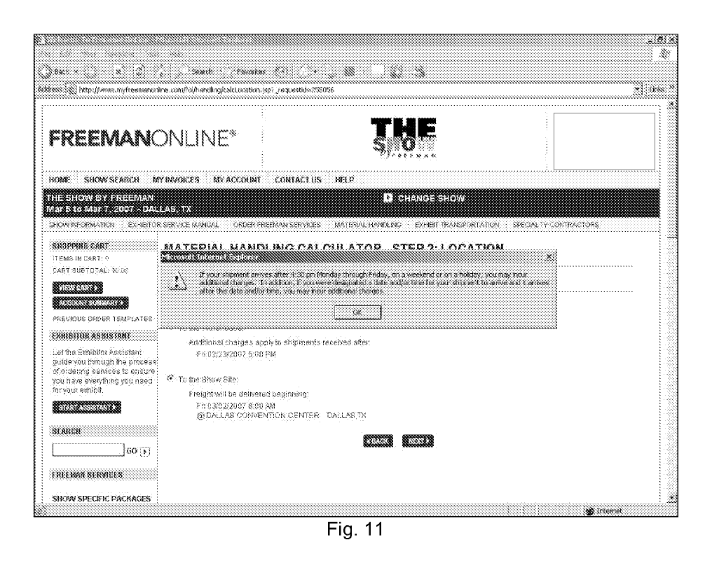

After the user selects the shipping location, the user may select the “Next” button. In some embodiments a popup window may appear with a message to the user based on the selected location. FIG. 11 illustrates one possible popup window that indicates to the user additional information. The popup window may have a close button so that the user can proceed with the material handling calculator 8.

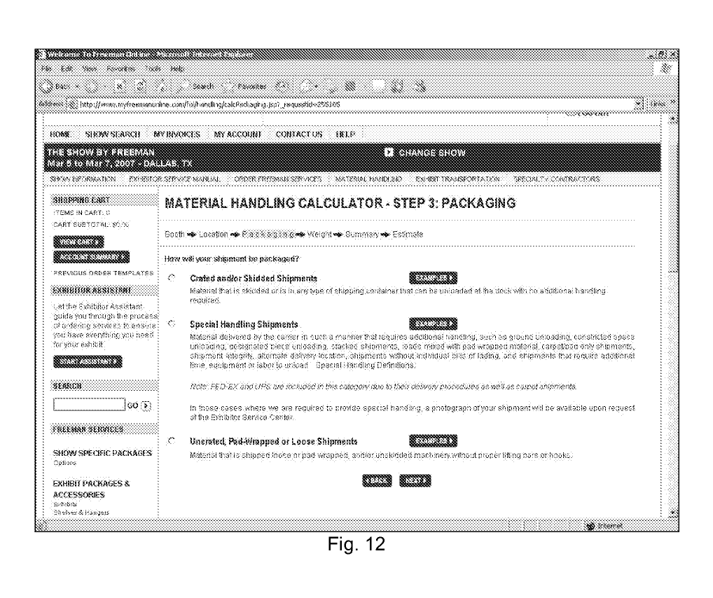

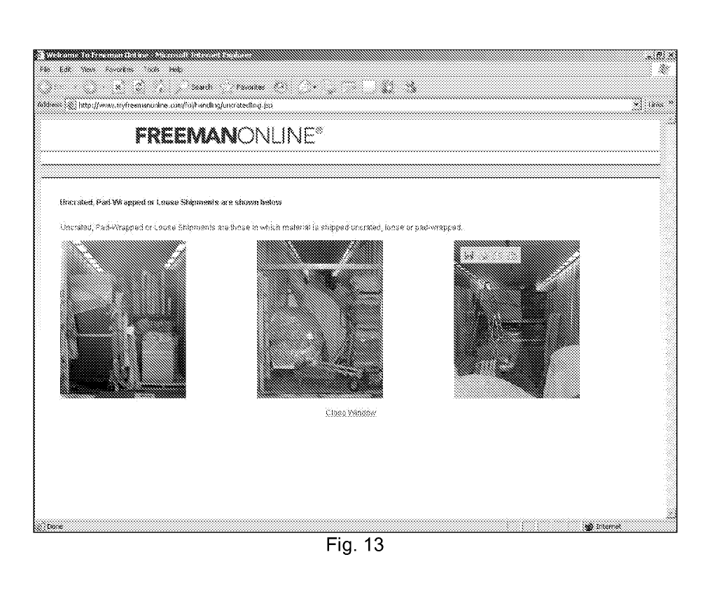

As illustrated in FIG. 12 (FIG. 1, block 24), the next screen may provide options for the user to select how the user's shipment will be packaged. As previously discussed, various packaging methods may incur different costs for material handling. As previously provided in FIG. 5 and further illustrated in FIGS. 6 and 7, descriptions and links to pictures of the packaging options may be presented. For example, the user may be provided with one or more of the following options to select from: crated, special handling, or uncrated. Importantly, this is not meant to be an exhaustive list, and other handling options known by those skilled in the art may also be included as options. FIG. 13 illustrates a screen that may be displayed when the “Example” hyperlink associated with the “Uncrated, Pad-Wrapped, or Loose Shipments” option is selected. Such a screen may open a new browser window to display the images along with a close window option. The user may select one of the options and click “Next” to continue.

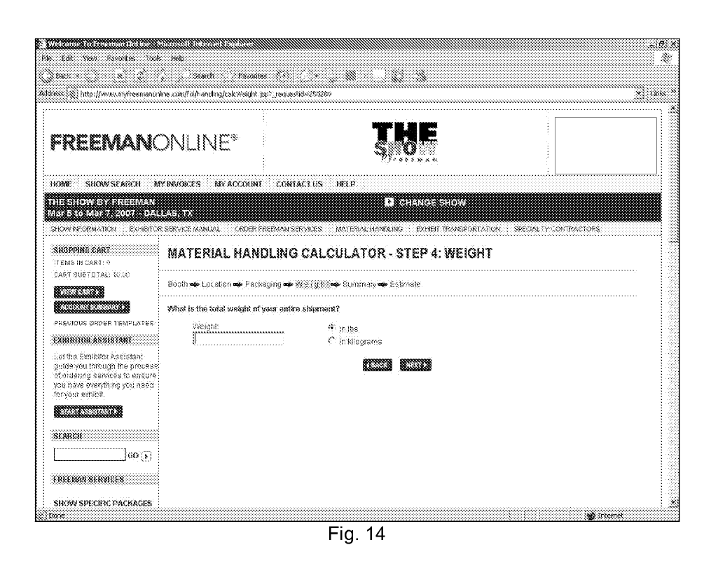

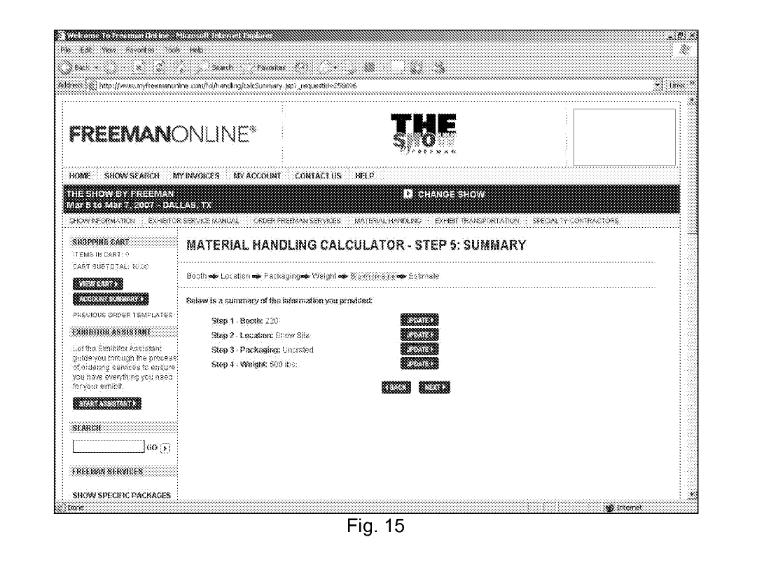

In accordance with the present embodiment, the next page may enable the user to enter the weight of the shipment in a screen such as shown in FIG. 14 (FIG. 1, block 26). In one embodiment, the user is prompted to enter the weight of the user's entire shipment in pounds, kilograms, or other units. For example, the weight field may accept numeric values from 100-999,999. In one embodiment, the default may be for the user to enter the weight in pounds. However, in other embodiments, the user may select kilograms. Once the weight has been entered the user may select the “Next” button to proceed to a page such as is illustrated in FIG. 15.

In one embodiment, a page as shown in FIG. 15 (FIG. 1, block 28) may display some or all of the user entered values from the previous steps. In addition, the page may allow the user to go back and edit any of those values. In the present embodiment, the displayed page may also initiate the calculation of the estimate for material handling when the “Next” button is selected.

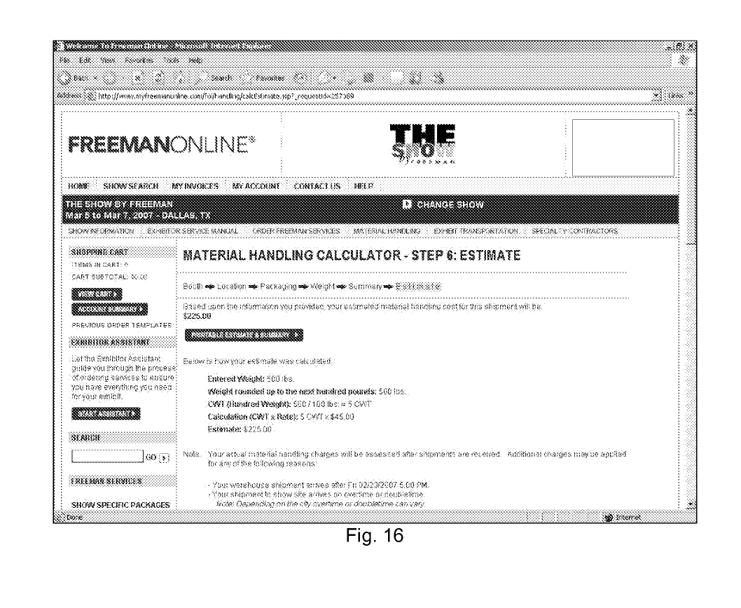

When the material handling calculator 8 calculates the estimate the system may first calculate the hundred weight (CWT) from the entered weight. The CWT may be calculated by rounding the entered weight to the next number divisible by 100 and then dividing by 100. The rate applicable to the selected exhibition may then be multiplied by the CWT to derive the estimated cost, which may be displayed on a page as illustrated in FIG. 16. The system may determine the rate based, at least in part on, the location and packaging entries. In other embodiments, the calculation may be performed through various methods known to those skilled in the art. For example, the weight in pounds or kilograms may be directly used to calculate the estimate rather than using the CWT.

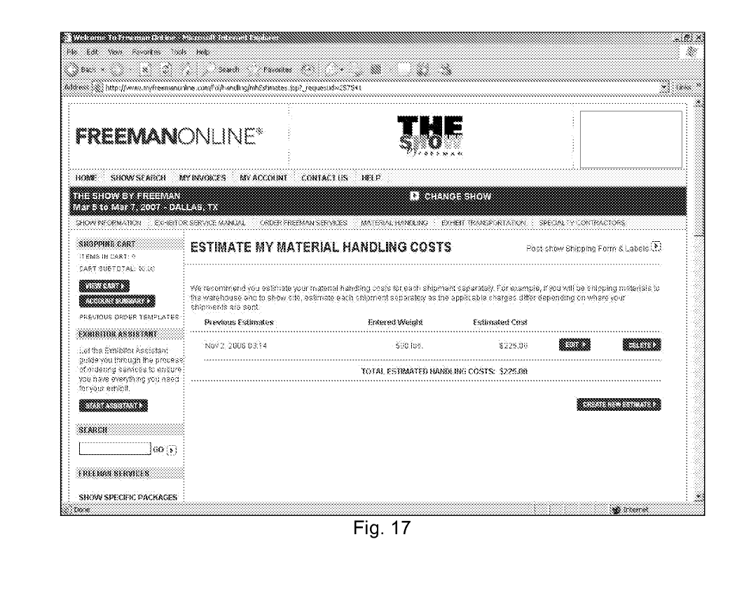

In one embodiment, a page like FIG. 16 (FIG. 1, block 30) may display the estimated material handling cost based, at least in part, on the user selections. As illustrated, an explanation of how the total cost was calculated may also be displayed. In another embodiment, the page may also display a disclaimer that the material handling calculator 8 is only providing an estimate and that other factors may cause the actual cost to be different. From this page the user can save the estimate and view all of the saved estimates as shown in FIG. 17 (FIG. 1, block 32). As may be appreciated, a number of different pages and screens for saving the estimate and for displaying other saved information may be provided.

As illustrated in FIG. 1, from the estimator page (block 30) the user may be directed back to the material handling main page to create a new estimate or may also go directly to an order summary (block 34).

In one alternative embodiment, a link may be included on one or more pages that opens a new browser window in which a variety of information may be displayed. For example, the information displayed may include, but need not be limited to, the user's selections, show name, and the calculated estimate in a printable format.

In another embodiment, the pages presented may include a navigation pane. As illustrated in, for example, FIG. 15, a left navigation pane may include options for accessing other pages and information. In further embodiments, the pages as connected in FIG. 1 may be linked or navigated in a number of different ways. In addition, the pages presented may also provide a link to various options relating to the shipping and material handling. For example, the left navigation pane may include one or more of the options as hyperlinks such as material handling definitions, estimators, FAQ/tips, and material handling rates. The pages presented may further include a link to direct the user to the main page.

In another embodiment, an order summary page may include the summary of all existing material handling estimates for the currently selected show or for a number of shows. In one embodiment, the total of the material handling calculator 8 estimates may also be added to an order total for that show at the bottom of the page. According to one embodiment, if no estimates exist and the show is not a package show, the link may still exist by include a total of zero.

The material handling calculator 8 main page may also provide the functionality to add and delete one or more of the existing estimates. According to one embodiment, the page displays the estimate name, weight, an estimated cost for each line item per user and show.

In accordance with another embodiment, the material handling calculator 8 main page may display one or more of the existing estimates as line items. The line items may include, for example, the estimate name provided by the user, the weight, line item estimate total, and the like. In one embodiment, each line item may have a delete button which can be used to remove estimates. Furthermore, all of the line item totals may be summed for a total material handling calculation.

According to another embodiment, if estimates do not exist, the estimate table may not be displayed. In this case, the user may be presented with an option to perform one or more functions. In one embodiment, the user may be presented with a button for creating a new estimate. In this case, for example, a button for creating a new estimate allows the user to go through the above described calculator 8 to add new estimates. According to one embodiment, the next page may allow the user to identify the booth for which the materials are being shipped.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. An automated method for assisting a user in estimating material handling costs for delivering materials to an exhibition booth comprising:
electronically soliciting from a user a booth number where the materials for the exhibition booth will be displayed;
electronically soliciting from the user a location to which the materials are going to be shipped;
electronically soliciting from the user a description of how the materials are packed for shipment;
electronically soliciting from the user a weight of the materials to be shipped;
storing electronically the information provided by the user;
electronically calculating a cost associated with handling the materials based upon the solicited information; and
displaying the cost to the user.

2. The method of claim 1 wherein soliciting information further comprises presenting the user with a list of selectable options.

3. The method of claim 2 wherein the user may select only one of the options.

4. The method of claim 1 wherein electronically soliciting additional information further comprises selecting an exhibition for which costs will be estimated.

5. The method of claim 1 electronically soliciting information from the user further comprises providing hyperlinks to a description of the packaging options.

6. The method of claim 5 wherein electronically calculating a cost includes selecting a rate based on how the materials are packed for shipment.

7. The method of claim 1 wherein electronically calculating the cost associated with handling the materials further comprises rounding the weight of the materials off to the next highest number divisible by 100.

8. An automated method for assisting a user in estimating the cost of material handling for presenting an exhibition booth comprising:
electronically providing a set of queries to a user relating to the materials to be displayed at an exhibition booth for an exhibition;
receiving answers in response to the queries, the answers indicating a characteristic of the materials and a packaging parameter;
electronically storing the answers;
electronically calculating a cost based upon the answers; and
summarizing the cost associated with the first set of queries and the additional set of queries.

9. The method of claim 8 wherein electronically providing a set of queries further comprises providing a query to determine a booth for which the user wants to determine a material handling estimate.

10. The method of claim 8 wherein electronically providing a set of queries further comprises providing a query to determine the location to which the user desires to ship the materials for the material handling estimate.

11. The method of claim 8 wherein electronically providing a set of queries further comprises providing a query to determine the weight of the materials for which the user wants to receive the material handling estimate and the answer indicating the weight.

12. The method of claim 11 wherein electronically calculating a based upon the answers further comprises rounding the weight of the materials off to the next highest number divisible by 100.

13. A system for estimating material handling costs for presenting an exhibition booth comprising:
a database of queries relating to presenting the exhibition booth;
a database of rates electronically linked to the database of queries;
a user interface for presenting a user with the queries in a desired order;
a means for electronically storing answers to the queries provided by the user; and
a means for electronically calculating an estimate based upon the answers to the queries provided by the user and the database of rate.
